(19) United States
(12) Patent Application Publication
(10) Pub. No.: US 2026/0225462 A1
(43) Pub. Date: Aug. 6, 2026

(54) SYSTEMS AND METHODS FOR POWER BASED LOAD MATCHING

(71) Applicant: Deere & Company, Moline, IL (US)

(72) Inventors: Sujith Vijaya KUMAR, Fuquay Varina, NC (US); Jacob C. KALLARA, Cary, NC (US); Eric R. LINN, Kindred, ND (US); Selin YAMAN, Apex, NC (US)

(73) Assignee: Deere & Company, Moline, IL (US)

(21) Appl. No.: 19/046,002

(22) Filed: Feb. 5, 2025

(51) Int. Cl. B60L 15/20; A01D 34/64; A01D 34/78; A01D 101/00; B60K 17/28; B60L 58/12

(52) U.S. Cl. CPC B60L 15/20; A01D 34/64; A01D 34/78; B60K 17/28; B60L 58/12; A01D 2101/00; B60L 2240/421; B60L 2240/427

(57) ABSTRACT

In an example embodiment, an electric turf vehicle includes a motor; an electric power source; and a controller configured to cause the vehicle to obtain an available discharge power of the electric power source, obtain a measured discharge power of the electric power source, determine a derated command based on the available discharge power and the measured discharge power, and controlling a voltage to the motor based on the derated command.

### FIELD

Example embodiments are related to systems and methods for power based load matching.

### SUMMARY

At least one example embodiment provides an electric turf vehicle comprising a motor; an electric power source; and a controller configured to cause the vehicle to obtain an available discharge power of the electric power source, obtain a measured discharge power of the electric power source, determine a derated command based on the available discharge power and the measured discharge power, and control a voltage to the motor based on the derated command.

According to at least one example embodiment, the controller is configured to cause the vehicle to obtain a measured discharge voltage of the electric power source, determine a first power, the first power being based on the measured discharge voltage and a current limit of the electric power source, and determine the derated command based on the measured discharge power and the first power.

According to at least one example embodiment, the controller is configured to cause the vehicle to determine a first derated value when the measured discharge power exceeds a first threshold, the first threshold being set based on the available discharge power and being less than the available discharge power, and determine the derated command based on the first derated value.

According to at least one example embodiment, the controller is configured to cause the vehicle to gradually increase the derated command when the measured discharge power falls below the first threshold.

According to at least one example embodiment, the controller is configured to cause the vehicle to determine a first derated value when the measured discharge power exceeds a first threshold, the first threshold being set based on the available discharge power and being less than the available discharge power, determine a second derated value when the measured discharge power exceeds a second threshold, the second threshold being set based on the first power and being less than the first power, and determine the derated command based on the first derated value and the second derated value.

According to at least one example embodiment, the derated command is the greater of the first derated value and the second derated value.

According to at least one example embodiment, the electric turf vehicle further includes mower blades; and a power take-off (PTO) configured to couple the motor to the mower blades.

According to at least one example embodiment, the controller is configured to cause the vehicle to apply the derated command to the control of the motor, and disengage the PTO to decouple the motor from the mower blades if the controller applies the derated command for a threshold period of time.

According to at least one example embodiment, the derated command is a command to derate a traction speed of the motor.

According to at least one example embodiment, a method of power based load matching for an electric turf vehicle comprises obtaining an available discharge power of an electric power source of the electric turf vehicle; obtaining a measured discharge power of the electric power source; determining a derated command based on the available discharge power and the measured discharge power; and controlling a voltage to a motor of the electric turf vehicle based on the derated command.

According to at least one example embodiment, the method further includes obtaining a measured discharge voltage of the electric power source; determining a first power, the first power being based on the measured discharge voltage and a current limit of the electric power source; and determining the derated command based on the measured discharge power and the first power.

According to at least one example embodiment, the method further includes determining a first derated value when the measured discharge power exceeds a first threshold, the first threshold being set based on the available discharge power and being less than the available discharge power, and the determining the derated command determines the derated command further based on the first derated value.

According to at least one example embodiment, the method further includes gradually increasing the derated command when the measured discharge power falls below the first threshold.

According to at least one example embodiment, the method further includes determining a first derated value when the measured discharge power exceeds a first threshold, the first threshold being set based on the available discharge power and being less than the available discharge power; and determining a second derated value when the measured discharge power exceeds a second threshold, the second threshold being set based on the first power and being less than the first power, and the determining the derated command determines the derated command further based on the first derated value and the second derated value.

According to at least one example embodiment, the derated command is the greater of the first derated value and the second derated value.

According to at least one example embodiment, the method further includes controlling mower blades of the electric turf vehicle; and controlling a power take-off (PTO) of the electric turf vehicle configured to couple the motor to the mower blades.

According to at least one example embodiment, the method further includes applying a derated command; and disengaging a power take-off (PTO) to decouple the motor from mower blades of the electric turf vehicle if the applying occurs for a threshold period of time.

According to at least one example embodiment, the derated command is a command to derate a traction speed of the motor.

According to at least one example embodiment, a non-transitory computer-readable medium stores instructions, when executed by a controller of an electric turf vehicle, cause the electric turf vehicle to obtain an available discharge power of an electric power source of the electric turf vehicle, obtain a measured discharge power of the electric power source, determine a derated command based on the available discharge power and the measured discharge power, and control a voltage to a motor of the electric turf vehicle based on the derated command.

According to at least one example embodiment, instructions, when executed by the controller, cause the electric turf vehicle to obtain a measured discharge voltage of the electric power source, determine a first power, the first power being based on the measured discharge voltage and a current limit of the electric power source, and determine the derated command based on the measured discharge power and the first power.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 illustrates an electric turf vehicle according to one or more example embodiments;

FIG. 2 is a block diagram of an electric drive system for an electrical machine, according to one or more example embodiments;

FIG. 3 is a block diagram of an electronic data processing system consistent with FIG. 1, according to an example embodiment;

FIG. 4 illustrates a load matching control system according to one or more example embodiments;

FIGS. 5A-5B are load matching control flow charts according to one or more example embodiments; and

FIG. 6 illustrates a timing diagram implementing the load matching according to one or more example embodiments.

### DETAILED DESCRIPTION

Some example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one embodiment of the invention relates to a non-transitory computer-readable storage medium comprising electronically readable control information stored thereon, configured in such that when the storage medium is used in a controller, at least one embodiment of the method is carried out.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects.

The term memory is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways. The term data storage device may be used interchangeably with computer-readable medium.

At least some example embodiments reduce and/or avoid unexpected shutdowns in electric turf vehicles such as mowers.

While mowing thick and/or tall grass (i.e., high load on the mower blades), a power consumed by the components on the mower from a battery could exceed an amount of power the battery has available to provide.

In such situations, the battery may issue a forewarning, letting the controllers on the vehicle know that the battery is operating outside its normal bounds and is about to open contactors in the next two seconds if operating conditions do not return to normal.

If the contactors do open under load, the battery contactor life could be reduced. That is undesirable. Therefore, in this situation, an Integrated Communications Controller (ICC) stops traction and blades and then commands a Battery Management System (BMS) to open the contactors to shut the machine down.

This shutdown, however, may appear abrupt to the operator as there is no prior indication before the machine shuts down. Once the mower is restarted, it may be difficult to figure out why the vehicle shut down. One way to figure out what happened previously is to enter a diagnostic mode and look for a stored code, which may not be intuitive to the operator.

Therefore, the frequency of these unexpected shutdowns should be minimized.

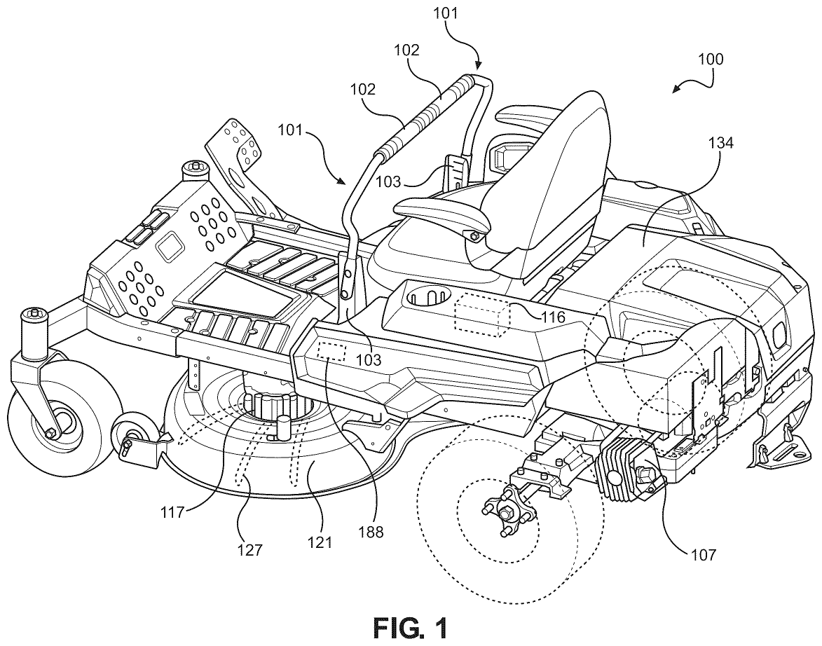

FIG. 1 illustrates an electric turf vehicle according to one or more example embodiments. In FIG. 1, an electric turf vehicle 100 may be a zero turn (ZTR) mower.

The electric turf vehicle 100 has a pair of control levers 101 to provide differential steering. Each control lever 101 may include handle 102 attached to steering bracket 103. Each control lever may be pivotably mounted to a base on a frame member adjacent an operator platform. Each control lever may be pivoted forward or rearward to steer the work vehicle by controlling the rotational speed of a traction drive motor 107 through a controller 116.

The controller 116 further controls an electric blade motor 117 to provide power to the electric blade motor 117. Blades 127 of the motor are located under a deck 121 of the electric turf vehicle 100.

The deck 121 includes an electric motor 117 to rotate one or more rotary cutting blades 127 underneath the deck 121. For example, the electric blade motors 117 may be electrically connected to an inverter 188. The inverter 188 may be electrically connected to an electric power source 134 that may provide electric power to the electric blade motor 117. The controller 116 may set the speed of the electric blade motor 117 based on the sensed rotational speed of the blades 127 under the deck 121 and an available discharge power and a measured discharge power of the electric power source 134. In some example embodiments, the electric power source 134 is a battery. However, example embodiments are not limited thereto.

The controller 116 may monitor the speed of the blades 127 under the deck 121. If the controller 116 detects an increase or drop in the speed (due to grass conditions or reduced mowing speed setting, for example), the controller may change the rotational speed of the electric blade motor 117 to change the rotational speed of the blades 127.

Movement control of the vehicle 100 is further described in U.S. application Ser. No. 18/069,243, filed Dec. 21, 2022, the entire contents of which are hereby incorporated by reference.

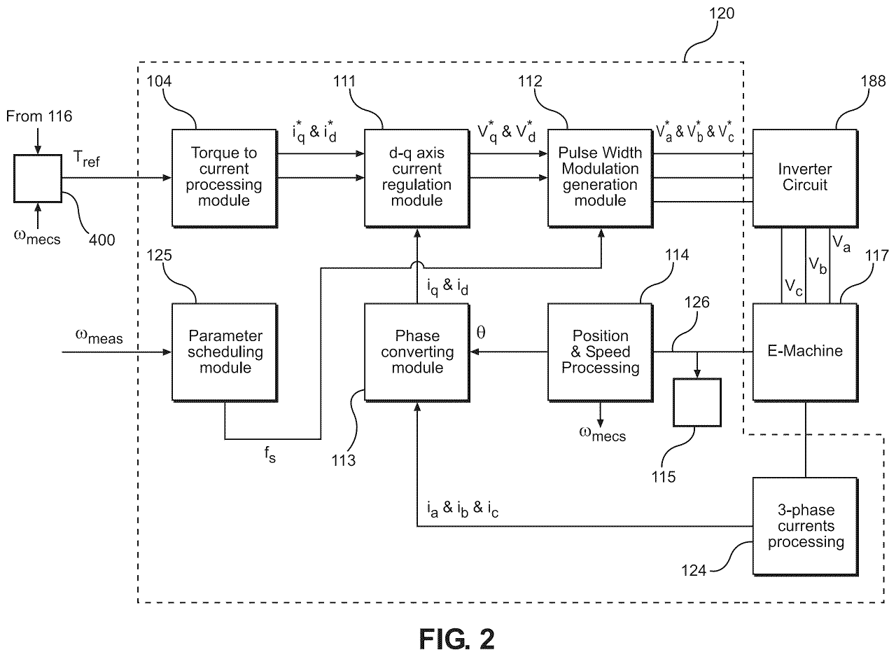

FIG. 2 is a block diagram of an electric drive system for an electrical machine, according to one or more example embodiments.

The electrical machine may be the motor 117 (e.g., an interior permanent magnet (IPM) motor) or another alternating current machine controlled by an electronic data processing system 120. Hereinafter, the terms, hybrid machine, electrical motor, AC machine and a motor may be used interchangeably. The motor 117 has a nominal dc bus voltage. The nominal voltage is a named voltage. In some example embodiments, a nominal voltage may be 32 VDC to 60 VDC. In other example embodiments, the nominal voltage may be 75 VDC to 1000V.

In an example embodiment, the electronic data processing system 120 may be referred to as an electric machine controller. The electronic data processing system 120 in combination with an inverter 188 may be referred to as an inverter system.

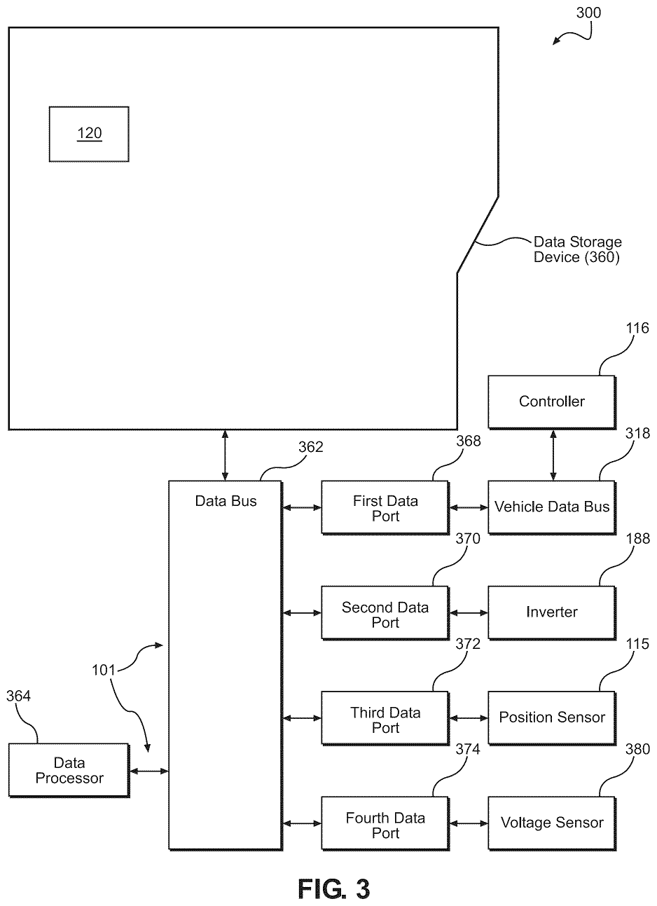

The electronic data processing system 120 includes electronic modules, software modules, or both. In an example embodiment, the electronic data processing system 120 includes at least one processor and a memory to support storing, processing and execution of software instructions of one or more software modules. The electronic data processing system 120 is indicated by the dashed lines in FIG. 2 and is shown in greater detail in FIG. 3.

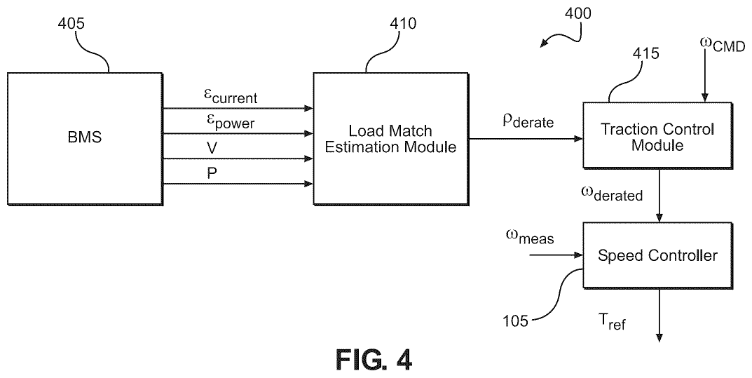

In an example embodiment, the data processing system 120 receives an input control data message, such as a speed control data message, a voltage control data message, or a torque control data message over a vehicle data bus 318 (shown in FIG. 3). A load matching control system 400 (described in detail with reference to FIG. 4) includes a speed controller (e.g., a PI controller) 105 that converts the received input control message into a reference torque T_{ref} based on a measured speed ωₘₑₐₛ. For example, the PI controller 105 may determine a difference between a requested speed in the speed control data message (or derated speed ω_{derated}) and the measured speed ωₘₑₐₛ and generate the reference torque T_{ref} based on the difference. The reference torque T_{ref} may also be referred to as a torque command. A torque to current processing module 104 generates one or more outputs (e.g., direct axis current command (i_{d}*) and quadrature axis current command (i_{q}*)) based on the reference torque T_{ref}. More specifically, the torque to current processing module 104 may include d-q axis current generation look-up tables that indicates d-q current commands for a particular reference torque. The d-q axis current refers to the direct axis current and the quadrature axis current as applicable in the context of vector-controlled alternating current machines, such as the motor 117. The one or more outputs of the current processing module 104 are provided or coupled to a current regulation module 111. While the term current command is used, it should be understood that current command refers to a target current value.

The current regulation module 111 is capable of communicating with a pulse-width modulation (PWM) generation module 112 (e.g., space vector PWM generation module). The current regulation module 111 receives respective d-q axis current commands (e.g., i_{d}* and i_{q}*), and actual d-q axis currents (e.g., i_{d} and i_{q}) and outputs corresponding d-q axis voltage commands (e.g., v_{d}* and v_{q}* commands) for input to the PWM generation module 112.

In an example embodiment, the PWM generation module 112 converts the d-q axis voltage commands from two phase data representations into three phase representations (e.g., three phase voltage representations, such as vₐ*, v_{b}* and v_{c}*) for control of the motor 117 using a switching frequency fₛ. The three phase voltage representations vₐ*, v_{b}* and v_{c}* may be referred to as inverter terminal voltages. Outputs of the PWM generation module 112 are coupled to the inverter 188 (an inverter circuit). The output stage of the inverter 188 (e.g., output terminal voltages vₐ, v_{b} and v_{c}) provides a pulse-width modulated voltage waveform or other voltage signal for control of the motor 117. In an example embodiment, the inverter 188 is powered by a direct current (DC) voltage bus. As will be further described below, there may be more than one inverter in the inverter 188. For example, there may be a generator side inverter associated with a generator machine and a separate inverter (load inverter) associated with the load machine (load motor 117). In one example embodiment, if there is more than one load machine, then there may be a corresponding number of load inverters in the inverter 188.

Alternatively, there may be two or more inverter circuits 188, where each inverter circuit is either associated with either the generator machine or one or more load machines.

In one example embodiment, the inverter 188 is a semiconductor drive circuit that drives or controls switching semiconductors (e.g., insulated gate bipolar transistors (IGBT) or other power transistors, including but not limited to, a metal-oxide Semiconductor Field-Effect Transistor (MOSFET), a Silicon Carbide MOSFET or a Silicon Carbide IGBT) to output control signals for the motor 117. In turn, the inverter 188 is coupled to the motor 117.

Each transistor is coupled electrically to a respective gate driver that is dedicated to that transistor and may provide a low DC voltage (e.g., 24 VDC) to turn on and off that transistor. The gate drivers are under the control of the processing circuitry, which may employ a pulse-width-modulation control scheme to control those gate drivers to supply electric energy on a direct current (DC) bus in a generating mode. In example embodiments, space vector modulation may be used. In other example embodiments, the gate drivers are under the control of the processing circuitry, which may employ a pulse-width-modulation control scheme to remove electric energy from the DC bus in a motoring mode.

The motor 117 is associated with a sensor 115 (e.g., a position sensor, a resolver or encoder position sensor) that is associated with a motor shaft 126 or the rotor. The sensor 115 and the motor 117 are coupled to the electronic data processing system 120 to provide feedback data (e.g., current feedback data, such as phase current values iₐ, i_{b} and i_{c}), raw position signals, among other possible feedback data or signals, for example. Other possible feedback data includes, but is not limited to, winding temperature readings, semiconductor temperature readings of the inverter 188, three phase voltage data, or other thermal or performance information for the motor 117.

The motor 117 is associated with the sensor 115 (e.g., a resolver, encoder, speed sensor, or another position sensor or speed sensors) that estimates at least one of an angular position of the motor shaft 126, a speed or velocity of the motor shaft 126, and a direction of rotation of the motor shaft 126. The sensor 115 may be mounted on or integral with the motor shaft 126. The output of the sensor 115 is capable of communication with the position and speed processing module 114. In an example embodiment, the sensor 115 may be coupled to an analog-to-digital converter (not shown) that converts analog raw position data or velocity data to digital raw position or velocity data, respectively. In other example embodiments, the sensor 115 (e.g., digital position encoder) may provide a digital data output of raw position data or velocity data for the motor shaft 126 or rotor.

A first output (e.g., position data θ for the motor 117) of the position and speed processing module 114 is communicated to a phase converting module 113 (e.g., three-phase to two-phase current Park transformation module) that converts respective three-phase digital representations of measured current into corresponding two-phase digital representations of measured current. A second output (e.g., measured speed data ωₘₑₐₛ for the motor 117) of the primary processing module 114 is communicated to a parameter scheduling module 125.

An input of a 3-phase current processing module 124 is coupled to terminals of the motor 117 for sensing at least the measured three-phase currents and a voltage level of the direct current (dc) bus (e.g., high voltage dc bus which may provide dc power to the inverter 188). The 3-phase current processing module 124 may include a dedicated current sensor or may be a sensorless processing module. The 3-phase current processing digitizes the three phase currents iₐ, i_{b} and i_{c}. The 3-phase current processing module 124 is associated with the motor 117 for measuring three phase currents (e.g., current applied to the windings of the motor 117, back EMF (electromotive force) induced into the windings, or both).

Certain outputs of the 3-phase current processing module 124 feed the phase converting module 113. For example, the phase converting module 113 may apply a Park transformation or other conversion equations (e.g., certain conversion equations that are suitable are known to those of ordinary skill in the art) to convert the measured three-phase representations of current into two-phase representations of current based on the digital three-phase current data iₐ, i_{b} and i_{c} from the 3-phase current processing module 124 and position data θ from the position and speed processing module 114. The output of the phase converting module 113 (i_{d}, i_{q}) is coupled to the current regulation module 111.

The torque to current processing module 104 selects or determines the direct axis current command and the quadrature axis current command associated with the respective reference torque T_{ref} (i.e., a respective torque command. For example, the torque to current processing module 104 selects or determines the direct axis current command and the quadrature axis current command by accessing one or more of the following: (1) a look-up table, database or other data structure that relates respective torque commands to corresponding direct and quadrature axes currents, (2) a set of quadratic equations or linear equations that relate respective torque commands to corresponding direct and quadrature axes currents, or (3) a set of rules (e.g., if-then rules) that relates respective torque commands to corresponding direct and quadrature axes currents such as rules relating to rotor magnet temperature, torque load on the motor 117, speed of the motor 117 and terminal voltage.

In an example embodiment, the motor 117 may include an interior permanent magnet (IPM) machine or a synchronous IPM machine (IPMSM).

The sensor 115 (e.g., shaft or rotor speed detector) may include one or more of the following: a direct current motor, an optical encoder, a magnetic field sensor (e.g., Hall Effect sensor), magneto-resistive sensor, and a resolver (e.g., a brushless resolver). In one configuration, the sensor 115 includes a position sensor, where raw position data and associated time data are processed to determine speed or velocity data for the motor shaft 126. In another configuration, the sensor 115 includes a speed sensor, or the combination of a speed sensor and an integrator to determine the position of the motor shaft.

In yet another example embodiment, the sensor 115 includes an auxiliary, compact direct current generator that is coupled mechanically to the motor shaft 126 of the motor 117 to determine speed of the motor shaft 126, where the direct current generator produces an output voltage proportional to the rotational speed of the motor shaft 126. In still another configuration, the sensor 115 includes an optical encoder with an optical source that transmits a signal toward a rotating object coupled to the motor shaft 126 and receives a reflected or diffracted signal at an optical detector, where the frequency of received signal pulses (e.g., square waves) may be proportional to a speed of the motor shaft 126. In an additional configuration, the sensor 115 includes a resolver with a first winding and a second winding, where the first winding is fed with an alternating current, where the voltage induced in the second winding varies with the frequency of rotation of the rotor.

The electronic data processing system 120 further includes a parameter scheduling module 125. The parameter schedule module 125 generates the switching frequency fₛ based on the measured speed ωₘₑₐₛ. In an example embodiment, the parameter schedule module 125 may include a table that stores sampling frequencies for respective measured speeds.

FIG. 3 is a block diagram of an electronic data processing system consistent with FIG. 2, according to an example embodiment. In FIG. 3, the electronic data processing system 300 includes an electronic data processor 364, a data bus 362, a data storage device 360, and one or more data ports (368, 370, 372, 374 and 376). The data processor 364, the data storage device 360 and one or more data ports are coupled to the data bus 362 to support communications of data between or among the data processor 364, the data storage device 360 and one or more data ports.

In an example embodiment, the data processor 364 may include an electronic data processor, a microprocessor, a microcontroller, a programmable logic array, a logic circuit, an arithmetic logic unit, an application specific integrated circuit, a digital signal processor, a proportional-integral-derivative (PID) controller, or another data processing device.

The data storage device 360 may include any magnetic, electronic, or optical device for storing data. For example, the data storage device 360 may include an electronic data storage device, an electronic memory, non-volatile electronic random access memory, one or more electronic data registers, data latches, a magnetic disc drive, a hard disc drive, an optical disc drive, or the like.

As shown in FIG. 3, the data ports include a first data port 368, a second data port 370, a third data port 372, a fourth data port 374 and a fifth data port 376. While in FIG. 3, 5 data ports are shown, any suitable number of data ports may be used. Each data port may include a transceiver and buffer memory, for example. In an example embodiment, each data port may include any serial or parallel input/output port.

In an example embodiment as illustrated in FIG. 3, the first data port 368 is coupled to a vehicle data bus 318. In turn, the vehicle data bus 318 is coupled to the controller 116. In one configuration, the second data port 370 may be coupled to the inverter 188; the third data port 372 may be coupled to the sensor 115; the fourth data port 374 may be coupled to at least one voltage sensor 380.

In an example embodiment, the torque reference T_{ref} is received through the vehicle data bus 318 via the controller 116 and speed controller 105. The first data port 368 may be coupled to the vehicle data bus 318, such as a controller area network (CAN) data bus. The vehicle data bus 318 may provide data bus messages with torque commands to the torque to current processing module 104 via the first data port 268. In other example embodiments, the operator of a vehicle may generate the torque commands via a user interface, such as a throttle, a pedal, the controller 266, or other control devices.

In one example embodiment, the PWM generation module 112 may communicate with the inverter 188 and/or the data processor 364 via the second data port 370. In some example embodiments, the sensor 115 may communicate with the position and speed processing module 114 and/or the data processor 364 via the third data port 372.

FIG. 4 illustrates a load matching control system according to one or more example embodiments. As shown in FIG. 4, a load matching control system 400 includes a battery management system (BMS) 405 of the power source 134, a load match estimation module 410, a traction control module 415 and the speed controller 105. In some example embodiments, the load match estimation module 410 and the traction control module 415 may be implemented by the controller 116. In other example embodiments, the load match estimation module 410 and the traction control module 415 may be implemented by the processor 364 executing instructions stored in the data storage device 360.

The BMS 405 may be any known BMS.

At lower traction speeds, the power consumed by the blades 127 reduces as it cuts lesser grass per unit time.

In some example embodiments, the load matching control system 400 compares the power being consumed from the electric power source 134 to the power available for consumption reported by the battery to reduce traction speed if the difference between the two reduces below a certain threshold.

In some example embodiments, the reduction in traction speed is tuned to be gradual as the difference in powers reduces. The traction speed could be reduced to as much as 10% of the commanded speeds. If even this lowest speed is not sufficient to reduce the power consumption from the battery, the load matching control system 400 will disable the blades 127 to protect the vehicle 100 from shutting down.

In some example embodiments, the reduction in traction speeds is triggered once a difference in available power and actual power consumed from the battery is less than 2 kW. The reduction in traction speeds is governed by a close loop algorithm as shown in FIGS. 4-6.

As shown in FIG. 4, the BMS 405 provides an available discharge power ε_{power} the power source 134, a discharge current limit ε_{current} of the power source 134, a measured discharge power P and a measured discharge voltage V to the load match estimation module 410. The measured discharge voltage V may be the same as the DC bus voltage. Thus, the measured voltage V may be measured/sensed by a voltage sensor placed across the DC bus. The measured discharge power P may be determined with a voltage sensor and a current sensor at an output of the battery. The controller may multiple the voltage sensed by the voltage sensory by the current sensed by the current sensor to determine the measured discharge power P.

Based on the available discharge power ε_{power} of the power source 134, the discharge current limit ε_{current} of the power source 134, the measured discharge power P and the measured discharge voltage V, the load match estimation module 410 determines a traction speed derate command ρ_{derate}, which indicates an amount (e.g., a percentage) to reduce the speed command ωCMD. The traction control module 415 obtains the traction speed derate command ρ_{derate} from the load match estimation module 410 and generates a derated speed command ω_{derated}. More specifically, the traction control module 415 derates the speed command ω_{CMD} by the amount indicated by the traction speed derate command ρ_{derate}. The speed controller 105 generates the reference torque T_{ref} using the derated speed command ω_{derated} instead of the speed command ω_{CMD}. In example embodiments, where load matching is not active, the derated speed command ω_{derated} is equal to the speed command ω_{CMD}.

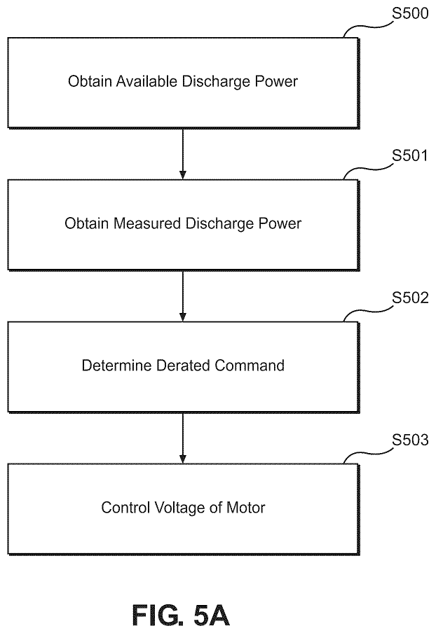

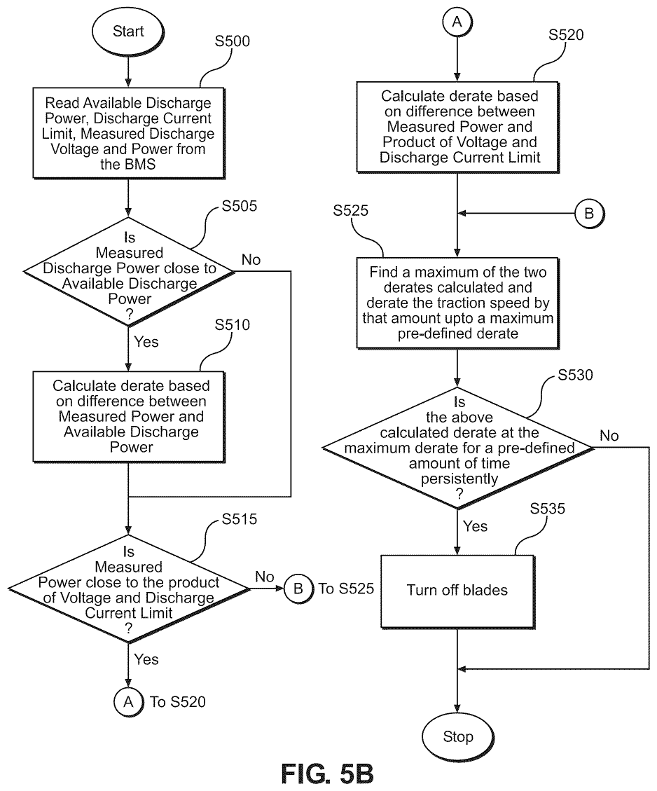

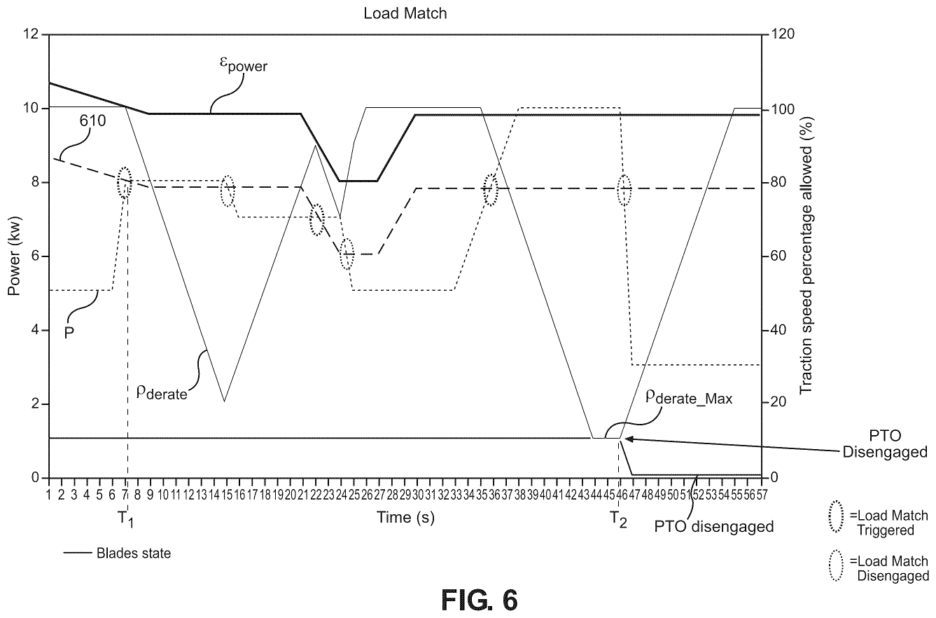

FIGS. 5A-5B are load matching control flow charts according to one or more example embodiments. FIG. 6 illustrates a timing diagram implementing the load matching according to one or more example embodiments.

The flow chart of FIG. 5A is implemented by the load matching control system 400. At S500, the load match estimation module 410 obtains the available discharge power ε_{power} of the power source 134. At S501, the load match estimation module 410 obtains a measured discharge power of the electric power source. At S503, the load match estimation module 410 determines a derated command based on the available discharge power and the measured discharge power. At S504, the load matching control system 400 controls a voltage to the motor based on the derated command.

The flow chart of FIG. 5B illustrates an example of the method shown in FIG. 5A.

The flow chart of FIG. 5B is implemented by the load matching control system 400. At S500, the load match estimation module 410 obtains the available discharge power ε_{power} of the power source 134, the discharge current limit ε_{current} of the power source 134, the measured discharge power P and the measured discharge voltage V from the BMS 405.

At S505, the load match estimation module 410 determines whether the actual discharge power P is within a threshold value of the available discharge power ε_{power}. If the actual discharge power P is not within the threshold value of the available discharge power εpower, the load estimation module 410 proceed to S515.

If the measured discharge power P is within a threshold value of the available discharge power ε_{power}, the load estimation module 410 calculates a traction speed derate command ρ_{derate} based on the difference between the actual discharge power P is close to the available discharge power ε_{power} at S510. Using FIG. 6 as an example, a buffer threshold 610 (first threshold) is set to be a first fixed value from the available discharge power ε_{power}. In some example embodiments, the buffer threshold 610 prevents the battery from faulting out if the actual discharge power remains above available discharge power ε_{power} for more time than the battery allows. The first fixed value may be determined through empirical data under different loads, State of Charge and temperature conditions, along with the information on the tolerance the battery offers to the machine drawing more power than what the battery determines is the limit. In an example embodiment, the first fixed value may be 2000 W. The buffer threshold 610 permits the system enough time to generate a first traction speed derate command ρ_{derate1} before the actual discharge power P reaches the available discharge power ε_{power}. The buffer threshold 610 may be determined from empirical data.

When the actual discharge power P reaches or exceeds the buffer threshold 610, the actual discharge power P is considered to be within the threshold value of the available discharge power ε_{power}. Thus, at time T1, the actual discharge power P is within the threshold value of the available discharge power ε_{power}, resulting in the load match estimation module 410 calculating the first traction speed derate command ρ_{derate1}. The first traction speed derate command ρ_{derate1} may be determined using a proportional-integral (PI) control loop based on a difference between the actual discharge power P and the threshold value of the available discharge power ε_{power}.

After S515, the load match estimation module 410 determines whether the measured discharge power is within a second value of a product of the voltage V and the discharge current limit ε_{current} (i.e., V*ε_{current}). More specifically, a second threshold is set based on the product of the voltage V and the discharge current limit ε_{current}. The second threshold is used to start reducing traction speeds before the current reaches the discharge current limit. In some example embodiments, the second threshold is set to be a second fixed value less than the product of the voltage V and discharge current limit ε_{current}. The second value may be a fixed value determined through empirical data. In some example embodiments, the second value may be 2000 W. When the measured discharge power exceeds the second threshold, the measured discharge power is considered within the second value of a product of the voltage V and the discharge current limit ε_{current}.

If the measured discharge power is not within the second value, the method proceeds to S525.

If the measured discharge power is within the second value, the load match estimation module 410 calculates a second traction speed derate command ρ_{derate2} based on the measured power and the product of the voltage V and the discharge current limit εcurrent at S520. The second traction speed derate command ρderate2 may be determined using a proportional-integral (PI) control loop based on a difference between the actual discharge power P and the threshold value of the available discharge power εpower.

At S525, the load match estimation module 410 determines the greater of the first traction speed derate command ρ_{derate1} and the second traction speed derate command ρ_{derate2} (e.g., which command has the greater derate percentage). The load match estimation module 410 uses the greater of the first traction speed derate command ρ_{derate1} and the second traction speed derate command ρ_{derate2} as the traction speed derate command ρ_{derate} and provides the traction speed derate command ρ_{derate} to the traction control module 415. The traction control module 415 derates the speed command ω_{CMD} by the amount indicated in the traction speed derate command ρ_{derate} up to a predetermined and/or selected derate threshold amount. If the derate command ρ_{derate} exceeds the predetermined and/or selected derate threshold amount, the traction control module applies the predetermined and/or selected derate threshold. Using FIG. 6 as an example, the predetermined and/or selected derate threshold is indicated by ρderate_max. In some example embodiments, the predetermined and/or selected derate threshold ρderate_max may be between 80-90%.

Referring back to FIG. 5, at S530, the load matching control system 400 determines whether the predetermined and/or selected derate threshold ρ_{derate_max} has been applied for a threshold amount of time. If the predetermined and/or selected derate threshold ρ_{derate_max} has been applied for a threshold amount of time, the loading matching control system 400 instructs provides instructions to the controller 116 to turn off the blades 127 (i.e., stop the motor 117) at S535. Using FIG. 6 as an example, the load matching control system 400 determines the predetermined and/or selected derate threshold ρ_{derate_max} has been applied for a threshold amount of time at T2, resulting in the blades stopping (PTO disengaged).

Furthermore, as shown in FIG. 6, the derate command ρ_{derate} ramps up and down as opposed to a more rectangular shape. This is a result of the load match estimation module 410 using a PI controller and results in a smoother transition between motor speeds.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. An electric turf vehicle comprising:
a motor;
an electric power source; and
a controller configured to cause the vehicle to,
obtain an available discharge power of the electric power source,
obtain a measured discharge power of the electric power source,
determine a derated command based on the available discharge power and the measured discharge power, and
control a voltage to the motor based on the derated command.

2. The electric turf vehicle of claim 1, wherein the controller is configured to cause the vehicle to,
obtain a measured discharge voltage of the electric power source,
determine a first power, the first power being based on the measured discharge voltage and a current limit of the electric power source, and
determine the derated command based on the measured discharge power and the first power.

3. The electric turf vehicle of claim 2, wherein the controller is configured to cause the vehicle to,
determine a first derated value when the measured discharge power exceeds a first threshold, the first threshold being set based on the available discharge power and being less than the available discharge power, and
determine the derated command based on the first derated value.

4. The electric turf vehicle of claim 3, wherein the controller is configured to cause the vehicle to,
gradually increase the derated command when the measured discharge power falls below the first threshold.

5. The electric turf vehicle of claim 2, wherein the controller is configured to cause the vehicle to,
determine a first derated value when the measured discharge power exceeds a first threshold, the first threshold being set based on the available discharge power and being less than the available discharge power,
determine a second derated value when the measured discharge power exceeds a second threshold, the second threshold being set based on the first power and being less than the first power, and
determine the derated command based on the first derated value and the second derated value.

6. The electric turf vehicle of claim 5, wherein the derated command is the greater of the first derated value and the second derated value.

7. The electric turf vehicle of claim 1, further comprising:
mower blades; and
a power take-off (PTO) configured to couple the motor to the mower blades.

8. The electric turf vehicle of claim 7, wherein the controller is configured to cause the vehicle to,
apply the derated command to the control of the motor, and
disengage the PTO to decouple the motor from the mower blades if the controller applies the derated command for a threshold period of time.

9. The electric turf vehicle of claim 1, wherein the derated command is a command to derate a traction speed of the motor.

10. A method of power based load matching for an electric turf vehicle, the method comprising:
obtaining an available discharge power of an electric power source of the electric turf vehicle;
obtaining a measured discharge power of the electric power source;
determining a derated command based on the available discharge power and the measured discharge power; and
controlling a voltage to a motor of the electric turf vehicle based on the derated command.

11. The method of claim 10, further comprising:
obtaining a measured discharge voltage of the electric power source;
determining a first power, the first power being based on the measured discharge voltage and a current limit of the electric power source; and
determining the derated command based on the measured discharge power and the first power.

12. The method of claim 11, further comprising:
determining a first derated value when the measured discharge power exceeds a first threshold, the first threshold being set based on the available discharge power and being less than the available discharge power, and the determining the derated command determines the derated command further based on the first derated value.

13. The method of claim 12, further comprising:
gradually increasing the derated command when the measured discharge power falls below the first threshold.

14. The method of claim 11, further comprising:
determining a first derated value when the measured discharge power exceeds a first threshold, the first threshold being set based on the available discharge power and being less than the available discharge power; and
determining a second derated value when the measured discharge power exceeds a second threshold, the second threshold being set based on the first power and being less than the first power, and the determining the derated command determines the derated command further based on the first derated value and the second derated value.

15. The method of claim 14, wherein the derated command is the greater of the first derated value and the second derated value.

16. The method of claim 10, further comprising:
controlling mower blades of the electric turf vehicle; and
controlling a power take-off (PTO) of the electric turf vehicle configured to couple the motor to the mower blades.

17. The method of claim 16, further comprising:
applying a derated command; and
disengaging a power take-off (PTO) to decouple the motor from mower blades of the electric turf vehicle if the applying occurs for a threshold period of time.

18. The method of claim 10, wherein the derated command is a command to derate a traction speed of the motor.

19. A non-transitory computer-readable medium storing instructions, when executed by a controller of an electric turf vehicle, cause the electric turf vehicle to,
obtain an available discharge power of an electric power source of the electric turf vehicle,
obtain a measured discharge power of the electric power source,
determine a derated command based on the available discharge power and the measured discharge power, and
control a voltage to a motor of the electric turf vehicle based on the derated command.

20. The non-transitory computer-readable medium of claim 19, wherein the instructions, when executed by the controller, cause the electric turf vehicle to,
obtain a measured discharge voltage of the electric power source,
determine a first power, the first power being based on the measured discharge voltage and a current limit of the electric power source, and
determine the derated command based on the measured discharge power and the first power.
